(19) United States
(12) Patent Application Publication
(10) Pub. No.: US 2022/0410005 A1
(43) Pub. Date: Dec. 29, 2022

(54) METHOD FOR PLACING VIRTUAL OBJECT

(71) Applicant: Beijing Dajia Internet Information Technology Co., Ltd., Beijing (CN)

(72) Inventor: Chao Pei, Beijing (CN)

(21) Appl. No.: 17/576,249

(22) Filed: Jan. 14, 2022

(30) Foreign Application Priority Data
Jun. 23, 2021 (CN) 202110699650.X

(51) Int. Cl. A63F 13/56

(52) U.S. Cl. CPC A63F 13/56

(57) ABSTRACT

The present disclosure relates to a method for placing a virtual object. The method includes: obtaining a position information and a first movement direction of a first object in a first area displaying a virtual space; determining a target area based on the position information and the first movement direction, the target area being outside the first area and located by a side of the first area along the first movement direction; obtaining object placing configuration information; selecting a target object from all second objects based on the object placing configuration information; and placing the target object in the target area.

### CROSS-REFERENCE TO RELATED APPLICATION

The disclosure claims priority to Chinese Patent Application No. 202110699650.X filed on Jun. 23, 2021, the content of which is hereby incorporated by reference into this disclosure.

### FIELD

The disclosure relates to the field of computer technology, and more particularly, to a method for placing a virtual object, an electronic device and a storage medium.

### BACKGROUND

At present, various objects are generally included in the display of a virtual space. For example, items generally appear in a game to increase the effect of the game. In related art, items are generally generated at a fixed position, or generated at a random position independent of the game.

### SUMMARY

According to embodiments of the disclosure, a method for placing a virtual object is provided. The method includes: obtaining a position information and a first movement direction of a first object in a first area displaying a virtual space; determining a target area based on the position information and the first movement direction, the target area being outside the first area and located by a side of the first area along the first movement direction; obtaining object placing configuration information; selecting a target object from all second objects based on the object placing configuration information; and placing the target object in the target area.

According to embodiments of the disclosure, an electronic device is provided. The electronic device includes a processor; and a memory for storing instructions executable by the processor. The processor is configured to execute the instructions to perform the method for placing a virtual object according to the above embodiments of the disclosure.

According to embodiments of the disclosure, a non-transitory computer-readable storage medium is provided. When instructions in the storage medium are executed by a processor of an electronic device, the electronic device is caused to perform the method for placing a virtual object according to the above embodiments of the disclosure.

It is to be understood that both the foregoing general description and the following detailed description are exemplary and explanatory only and are not restrictive of the disclosure.

### BRIEF DESCRIPTION OF THE DRAWINGS

The drawings, which are incorporated in and constitute a part of this specification, illustrate embodiments consistent with the disclosure and, together with the description, serve to explain the principles of the disclosure, but may not constitute an improper limitation of the disclosure.

FIG. 1 is a schematic diagram illustrating an application environment according to some embodiments of the disclosure.

FIG. 2 is a flowchart of a method for placing a virtual object according to some embodiments of the disclosure.

FIG. 3 is a schematic diagram for displaying a virtual space according to some embodiments of the disclosure. FIG. 4 is a flowchart of a method for placing a virtual object according to some embodiments of the disclosure.

FIG. 5 is a schematic diagram illustrating a target area according to some embodiments of the disclosure.

FIG. 6 is a flowchart of determining a target area for placing a second object based on the position information and the first movement direction according to some embodiments of the disclosure.

FIG. 7 is a schematic diagram illustrating a target area according to some embodiments of the disclosure.

FIG. 8 is a flowchart of a method for placing a virtual object according to some embodiments of the disclosure.

FIG. 9 is a schematic diagram illustrating a sub area according to some embodiments of the disclosure.

FIG. 10 is a flowchart of selecting a target object from all second objects based on the placing a virtual object configuration information according to some embodiments of the disclosure.

FIG. 11 is a block diagram illustrating an apparatus for placing a virtual object according to some embodiments of the disclosure.

FIG. 12 is a schematic diagram illustrating an electronic device for multi-service processing according to some embodiments of the disclosure.

### DETAILED DESCRIPTION

To enable those skilled in the art to better understand the technical solutions of the disclosure, the technical solutions in embodiments of the disclosure will be described clearly and completely with reference to the drawings.

It should be noted that the terms such as “first” and “second” in the specification and claims and the drawings of the disclosure are used to distinguish similar objects, and not necessarily used to describe a specific order or sequence. It should be understood that the data used in this way may be interchanged with each other under appropriate circumstances so that the embodiments of the disclosure described herein may be implemented in a sequence other than those illustrated or described herein. The implementation manners described in the following embodiments do not represent all implementation manners consistent with the disclosure. Rather, they are merely examples of apparatuses and methods consistent with some aspects of the disclosure as detailed in the appended claims.

With reference to FIG. 1, FIG. 1 is a schematic diagram illustrating an application environment according to some embodiments of the disclosure. As illustrated in FIG. 1, the application environment may include a server 01 and a terminal 02. In some embodiments, the server 01 may be used for a background service of placing a virtual object. For example, the server 01 may be used for an update service of a game corresponding to object placing. In some embodiments, the server 01 may be an independent physical server, a server cluster or a distributed system composed of multiple physical servers, or a cloud server that can provide basic cloud computing services such as cloud services, cloud databases, cloud computing, cloud functions, cloud storage, network services, cloud communications, middleware services, domain name services, security services, content delivery network (CDN), and big data and artificial intelligence platforms.

In some embodiments, the terminal 02 may be used for object placing processing. In some embodiments, the terminal 02 may include, but is not limited to, an electronic device such as a smart phone, a desktop computer, a tablet computer, a notebook computer, a smart speaker, a digital assistant, an augmented reality (AR)/virtual reality (VR) device, a smart wearable device. In some embodiments, an operating system running on the electronic device may include, but is not limited to, Android system, IOS system, Linux, Windows, and the like.

In addition, it should be noted that what is illustrated in FIG. 1 is an application environment provided by the disclosure.

In some embodiments of the present disclosure, the server 01 and the terminal 02 may be directly or indirectly coupled through wired or wireless communication, which is not limited in this disclosure.

It should be noted that, the following figures show a possible sequence of steps, and in fact it is not limited to strictly follow this sequence. Some steps may be executed in parallel without relying on each other. User information (including but not limited to user equipment information, user personal information, user behavior information, etc.) and data (including but not limited to data for displaying, data for training, etc.) involved in the disclosure has been authorized by the user or fully authorized by all parties.

The present disclosure may be applied in a game that displays a virtual space, such as a rafting game, an air floating game, etc. The virtual space may include a first object, a second object, and environmental objects, or may also include virtual characters that represent game users. The first object and the second object may move with the movement of the environmental objects so as to simulate the real environment effect. The second object may be controlled to disappear when moves to an edge of a game interface. The environmental objects may include water, blue sky, white clouds, and so on. The environmental objects in the rafting game may be water, such as the sea. The environmental objects in the air floating game may be blue sky and white clouds. The present disclosure does not limit these.

Taking the rafting game as an example, the first object may refer to a raft, and the second object may refer to floating objects (such as garbage) in the water, such as tree branches, iron wires, and drift bottles. The game user may perform preset operations on the second object, such as salvaging the second object. If the salvage is successful, level information of the game user may be updated based on a total number of salvaged second objects. For example, the more the total number of salvaged second objects, the higher the level represented by the corresponding level information is. The salvage operation may be executed by a virtual character, and the execution process may be displayed in the game interface.

In some embodiments of the present disclosure, the salvage behavior may be monitored to prevent the game user from cheating. For example, a salvage duration threshold may be set to 3s. If a salvage duration is less than 3s, the salvage may be determined to be a cheating behavior, the salvage may be set as invalid, and “this salvage is invalid” may be prompted in a floating window.

In some embodiments, when it is detected that the second object collides with the first object, a special effect may be displayed, for example, a special effect in which the second object gradually disappears, which is not limited in the present disclosure.

The above is an introduction to the scenarios of the present disclosure, the object placing process will be introduced below.

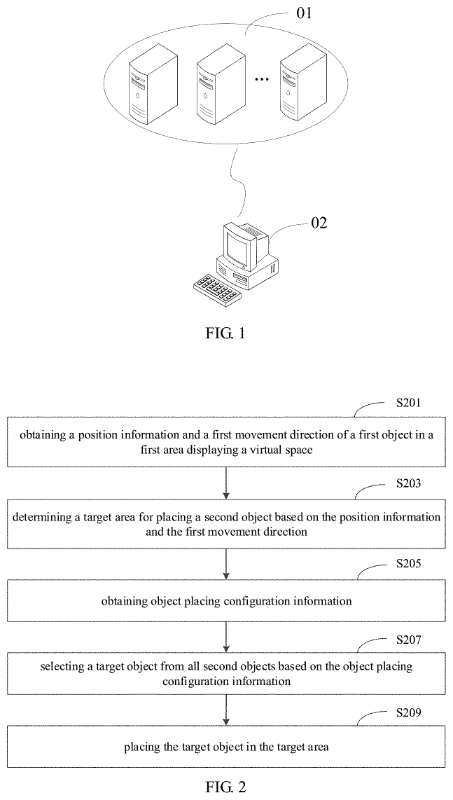

FIG. 2 is a flowchart of a method for placing a virtual object according to some embodiments of the disclosure. In this embodiment, the method for placing a virtual object may be performed by the terminal illustrated in FIG. 1. As illustrated in FIG. 2, the method for placing a virtual object may include the following actions in S201 to S209.

In S201, a position information and a first movement direction of a first object in a first area displaying a virtual space are obtained.

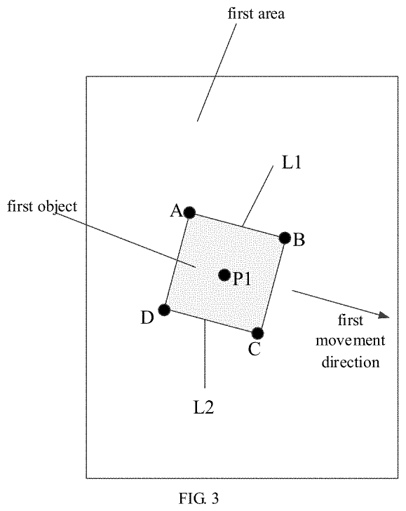

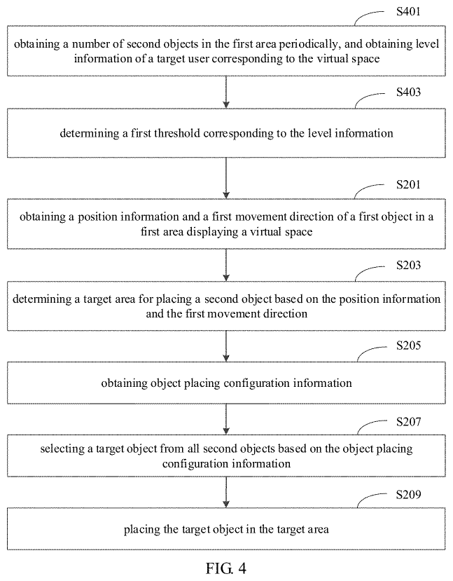

In some embodiments of the present disclosure, the first area may refer to a game interface, i.e., an interface that a user can see in a game. The position information and the first movement direction of the first object in the first area may be obtained. As shown in FIG. 3, the first object is ABCD. The ABCD may be in a shape of a raft, which is not limited in the present disclosure. The position information of the raft may be coordinates of the center P1 of the raft, or may be the sides L1 (AB) and L2 (DC) of the raft along the first movement direction.

It should be noted that, a velocity of the first object in the virtual space and a velocity of an environment object may be the same. That is, speed and a movement direction of the first object are the same as speed and a movement direction of the environment object. The speed of the first object and the speed of the environment object may be changed with time, i.e., have a mapping relationship with game time, so that the speed of the first object and the speed of the environment object may be changed correspondingly based on the time of entering the game, to realize authenticity of the virtual space.

In some embodiments, as illustrated in FIG. 4, before S201, the method for placing a virtual object may include the following actions in S401 to S403.

In S401, a number of second objects in the first area is periodically obtained and level information of a target user corresponding to the virtual space is obtained. The periodicity may refer to a heartbeat cycle, such as 1 second. The target user corresponding to the virtual space may refer to a user viewing the virtual space, or may refer to a user playing a game in the virtual space.

In S403, a first threshold corresponding to the level information is determined.

The first threshold may be a threshold about the number of second objects, and may also be referred to a second object number threshold. In practical application, a mapping relationship between level information of the user and second object number thresholds may be preset. The higher a level represented by the level information, the larger a second object number threshold corresponding to the level information is, so that the user can salvage more garbage as the level improved. The second object number threshold corresponding to the level information of the target user may be determined based on the mapping relationship.

Correspondingly, S201 may include the following:

when the number of the second objects in the first area is less than the second object number threshold, the position information and the first movement direction of the first object in the first area displaying the virtual space is obtained. By executing the object processing method when the number of second objects in the first area is less than the second object number threshold, unnecessary resource consumption can be avoided, and the number of second objects in the first area can be flexibly controlled.

In S203, a target area for placing a second object is determined based on the position information and the first movement direction.

The target area is outside the first area and is located by a side of the first area along the first movement direction. As illustrated in FIG. 5, for example, the first movement direction points to a lower right corner, the target area may be located at a lower right position of the first area, and there is no intersection between the target area and the first area. That is, the target area may be outside the first area and located at a position that the first movement direction points to. It should be noted that, FIG. 5 is an example of the target area, and the present disclosure does not limit the shape and size of the target area, as long as the above relationship between the target area and the position information and the first movement direction can be satisfied, and the size requirement for placing area of the second object can be satisfied.

In S205, object placing configuration information is obtained.

In S207, a target object is selected from all second objects based on the object placing configuration information.

In some embodiments, the object placing configuration information may be preset, which is not limited in the present disclosure. For example, the object placing configuration information may include a placing weight of each second object and a number threshold per placing, so that the target object may be randomly selected from the all second objects based on the placing weight, and the number of the selected target objects may be a number between 0 and the number threshold per placing, which is not limited in the present disclosure. That is to say, the object placing process may be executed periodically, and in each execution, the target objects of a number between 0 and the threshold value per placing may be screened out for placing.

In S209, the target object is placed in the target area.

In practical application, the target object may be placed in the target area. For example, at least one initial position may be randomly determined in the target area, so that one or more target objects may be randomly placed in the at least one initial position. In addition, the target object may be controlled to move to the first area, and a specific movement speed is not limited in the present disclosure.

In some embodiments of the present disclosure, a rotation speed of the target object may also be set to enrich the floating effect, which is not limited in the present disclosure.

Based on the position information and the first movement direction of the first object in the first area displaying the virtual space, the target area for placing the second object is determined, so that the determination of the target area is related to the position in the virtual space in real time, and the target area can follow the real-time change of the position of the first object in the virtual space in real time, so as to ensure that the placing position of the second object can be changed in real time, improving the flexibility of placing. In addition, the target area is by the side of an edge of the first area that the first movement direction points to, so that the target area where the second object is placed is more in line with the real scene, which can ensure that the second object can naturally enter the first area in the subsequent time, making the simulation effect of the virtual space more realistic.

In some embodiments, the method for placing a virtual object may further include the following. A preset operation is performed when it is detected that the second object in the first area is triggered. Taking the rafting game as an example, it is detected that a branch in the first area is triggered, such as being clicked, and a salvage operation may be performed. The duration of the salvage operation may refer to a period from a trigger time point to a time point of successful salvage, and the time point of successful salvage may refer to a time point when the branch is salvaged onto the raft, i.e., a time point when a position of the branch matches a position of the raft. If the salvage is successful, corresponding rewards may be given. For example, a corresponding reward value may be given to the target user, and the reward value may be used to update the level information of the target user.

Further, legality of the preset operation may be verified to prevent cheating. For example, if the preset operation does not satisfy an operation condition, an alarm processing is performed. The operation condition may be a duration condition. For example, a duration condition of the salvage is that the duration is greater than or equal to 3 seconds. If a duration of a salvage operation is less than 3 seconds, it may be considered that the preset operation does not satisfy the operation condition, and an alarm processing such as an alarm prompt is performed.

In some embodiments, a mapping relationship between the level information and a size of the first object may also be set. For example, when the user enters the game, the raft may be displayed according to a raft size corresponding to the level information of the user. As the user continuously salvage the garbage in the game, the level information may be continuously updated, and the raft may be displayed according to a raft size corresponding to the updated level information. That is, the raft may gradually become larger as the level increases.

Through the setting of the preset operation, the second object can not only be watched, but also the interaction between the game user and the second object can be realized, and the user experience can be improved.

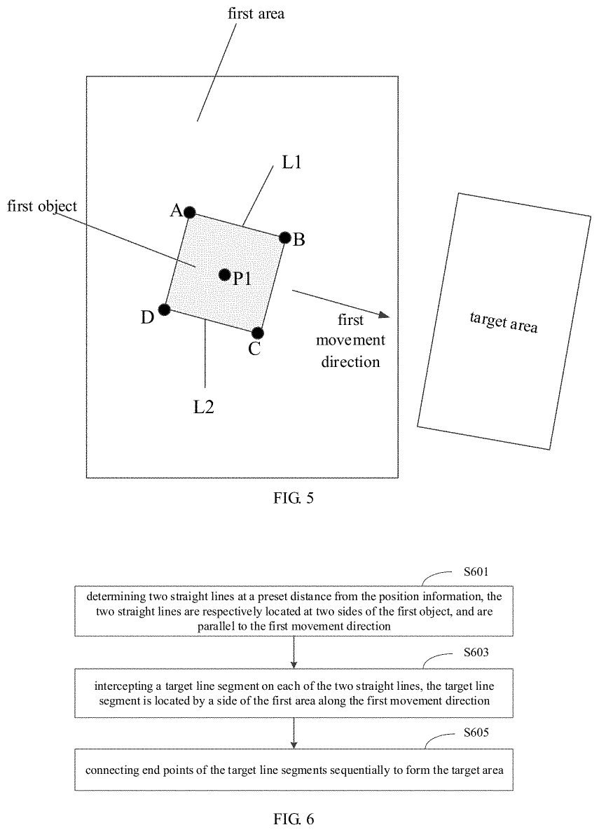

FIG. 6 is a flowchart of determining a target area for placing a second object based on the position information and the first movement direction according to some embodiments of the disclosure. In this embodiment, the method for determining a target area for placing a second object based on the position information and the first movement direction may be performed by the terminal. As illustrated in FIG. 6, in a possible implementation, the above S203 may include the following actions in S601 to S605.

In S601, two straight lines at a preset distance from the position information are determined. The two straight lines may be located at two sides of the first object respectively, and are parallel to the first movement direction.

In S603, a target line segment is intercepted on each of the two straight lines. The target line segment is located by a side of the first area along the first movement direction.

In S605, end points of the target line segments are sequentially connected to form the target area.

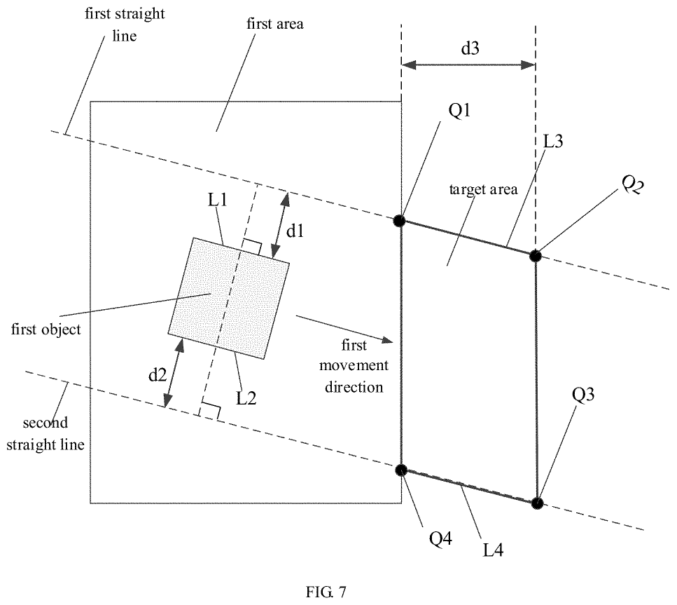

Wit reference to the schematic diagram of a target area illustrated in FIG. 7, the two straight lines may be: a first straight line and a second straight line. The first straight line and the second straight line are represented by dashed lines in FIG. 7. For example, as illustrated in FIG. 7, the first straight line, the second straight line, L1 and L2 may all be parallel to the first movement direction. The position information of the first object may include L1 and L2. The preset distance may be d1 and d2 as shown in FIG. 7, where d1 and d2 may be the same. The target area may be a quadrilateral Q1Q2Q3Q4 as shown in FIG. 7. The horizontal length of the target area may be d3, and the d3 may be 200 pixels, which is not limited in the present disclosure.

As illustrated in FIG. 7, the target line segment may be L3 (Q1Q2) and L4 (Q4Q3), endpoints of L3 may include Q1 and Q2, and endpoints of L4 may include Q3 and Q4, so that Q1, Q2, Q3, and Q4 may be sequentially connected to form the target area, which is not limited in the present disclosure, as long as the connection of Q1, Q2, Q3, and Q4 can form a closed area. Based on the first movement direction and the position information of the first object, the determined target area may be outside the first area and located by one side of the first area along the first movement direction, so that the drifting effect of the second object is more realistic.

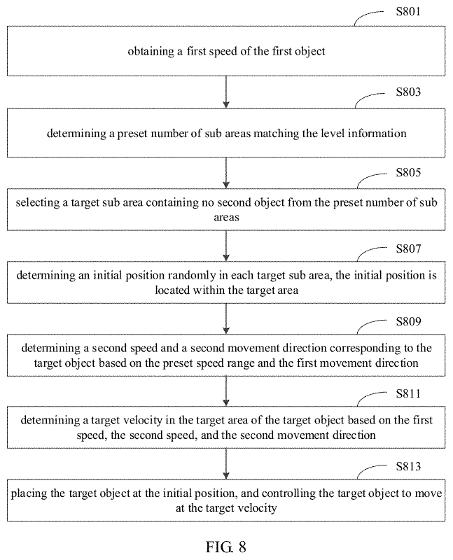

FIG. 8 is a flowchart of a method for placing a virtual object according to some embodiments of the disclosure. In this embodiment, the method for placing a virtual object may be performed by the terminal illustrated in FIG. 1. As illustrated in FIG. 8, in a possible implementation, the object placing configuration information may include a preset speed range corresponding to each second object, and the above S209 may include the following actions in S801 to S813.

In S801, a first speed of the first object is obtained.

In S803, a preset number of sub areas matching the level information are determined. The preset number of sub areas are obtained by dividing a second area along the first movement direction, and the second area may be obtained by splicing the first area and the target area. Thee preset number may be the same as the second object number threshold.

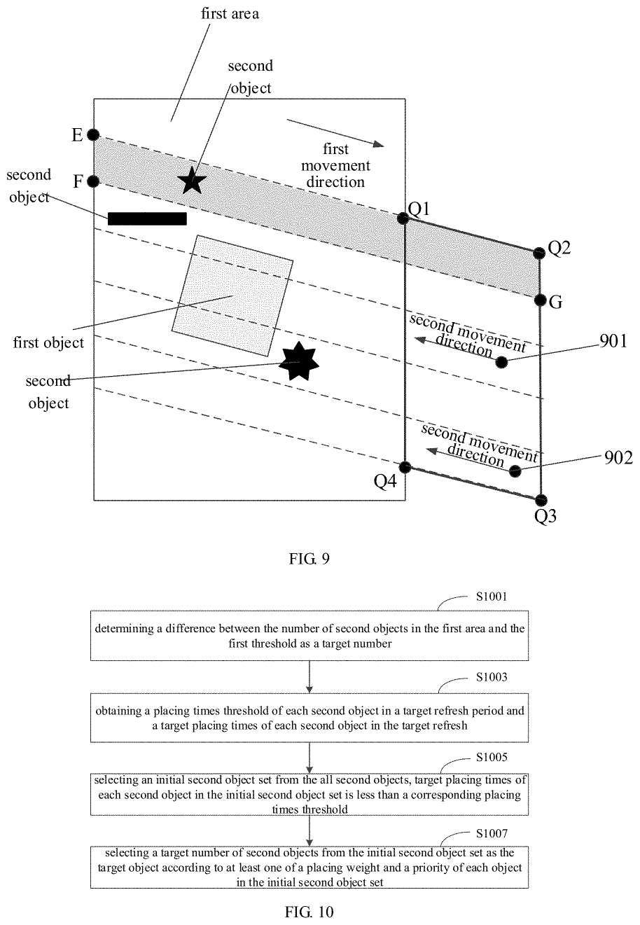

For example, as illustrated in the schematic diagram of the sub areas shown in FIG. 9, the preset number matching the level information matching is 5, and there may be 5 sub areas, as shown in FIG. 9. All of the five sub areas may be parallel to the first movement direction. The five sub areas may be the sub areas located between every two adjacent dashed lines in FIG. 9. For example, the gray area EFGQ2 may be a sub area. As shown in FIG. 9, the five sub areas may be called 5 race tracks, and all of the 5 race tracks may be parallel to the first movement direction. This is only an example, and the present disclosure does not limit it. It should be noted that, each second object moves in a corresponding sub area (track), the movement direction of the second object be opposite to the first movement direction.

In S805, a target sub area containing no second object is selected from the preset number of sub areas.

In S807, an initial position is determined randomly in each target sub area. The initial position is located within the target area.

As illustrated in FIG. 9, three of the five sub areas include a second object, and two sub areas do not include a second object. Therefore, the sub areas that do not include a second object in FIG. 9 may be used as target sub areas, such as sub areas where 901 and 902 are located. Therefore, an initial position may be randomly determined in an overlapping area of each target sub area and the target area. For example, the initial position may be 901 and 902 as shown in FIG. 9.

In S809, a second speed and a second movement direction corresponding to the target object are determined based on the preset speed range and the first movement direction.

In some embodiment of the present disclosure, a speed may be randomly determined from the preset speed range as the second speed corresponding to the target object. The second movement direction may be a direction pointing to the first area. In a possible implementation, the second movement direction may be opposite to the first movement direction, and the first movement direction has a preset angle with a central axis of the first area. For example, the second movement direction may be parallel to and opposite to the first movement direction, which is not limited in the present disclosure. Thus, stereoscopic vision may be presented and it facilitates one-handed operation.

In S811, a target velocity in the target area of the target object is determined based on the first speed, the second speed, and the second movement direction.

In S813, the target object is placed at the initial position, and the target object is controlled to move according to the target velocity.

In some embodiment of the preset disclosure, a difference value between the second speed and the first speed, i.e., the second speech minus the first speed, may be used as a speed of the target velocity, and the second movement direction may be used as a direction of the target velocity. Thus, the target object may be placed in the initial position, and the target object may be controlled to move according to the target velocity. By setting the sub area and determining the target velocity of the second object as a relative speed, the placing of the target object may simulate a real trajectory of an object in the virtual space, and the rendering effect of the virtual space is more realistic.

In some embodiments, S813 may include the following: number information and a number weight corresponding to each target object are obtained; a target placing number corresponding to each target object is determined based on the number information and the number weight; an initial position corresponding to each target object is determined; and the target placing number of target objects are placed at the initial position corresponding to each target object.

In some embodiments of the present disclosure, a target object may correspond to one or more pieces of number information. In the case of multiple pieces of number information, when determining which piece of number information is selected for a specific placing, the target placing number of each target object may be determined according to a weight corresponding to each piece of number information. The target placing number is one of multiple pieces of number information. The initial position where each target object is to be placed may also be determined, so the initial position corresponding to each target object may be determined. For example, the initial position corresponding to each target object may be determined in a random manner, which is not limited in the present disclosure.

In this way, the target placing number of target objects may be placed at the initial position corresponding to each target object. For example, two branches may be placed at an initial position corresponding to a tree. In some embodiments, the second object may be an image, and the image may be a three-dimensional model image. When the second object is placed, the three-dimensional model image may be displayed at an initial position.

By setting the number information and the number weight corresponding to each target object, it is possible to enable the number of placed target objects vary in different placing for the same target object, thus the object placing is more flexible.

FIG. 10 is a flowchart of selecting a target object from all second objects based on the object placing configuration information according to some embodiments of the disclosure. In this embodiment, the method for selecting a target object from all second objects based on the object placing configuration information may be performed by the terminal. In some embodiments of the present disclosure, the above S207 may include: selecting the target object from the all second objects based on the number of second objects in the first area, the second object number threshold, and the object placing configuration information. In this way, the selection of the target object is not only related to the object placing configuration information, but may also be related to the current number of second objects in the first area and dynamic user level information, improving the flexibility of selecting the target object.

In some embodiments, the object placing configuration information may further include a mapping relationship among at least one of each second object and a refresh time point, a placing times threshold in each refresh period, a placing weight, and a priority. For example, the mapping relationship may be as shown in Table 1 below.

TABLE 1

| | | placing times | | | |
|---|---|---|---|---|---|
| second | refresh | threshold | | | |
| object | time | in each | placing | | second |
| identification | point | refresh period | weight | priority | object |
| F1 | 14 o'clock, | 50 | 50 | high | image 1 |
| | 16 o'clock, | | | | |
| | 18 o'clock | | | | |
| F2 | 14 o'clock, | 100 | 50 | medium | image 2 |
| | 16 o'clock, | | | | |
| | 18 o'clock | | | | |
| F3 | 8 o'clock, | 100 | 30 | low | image 3 |
| | 18 o'clock | | | | |

As illustrated in FIG. 10, in some embodiments, the step of selecting the target object from the all second objects based on the number of second objects in the first area, the second object number threshold, and the object placing configuration information may include the following actions in S1001 to S1007.

In S1001, a difference between the number of second objects in the first area and the second object number threshold is determined as a target number.

In S1003, a placing times threshold of each second object in a target refresh period and a target placing times of each second object in the target refresh period are obtained. The target refresh period is a refresh period matching current time.

In S1005, an initial second object set is selected from the all second objects, target placing times of each second object in the initial second object set is less than a corresponding placing times threshold.

In S1007, a target number of second objects are selected from the initial second object set as the target object according to at least one of a placing weight and a priority of each object in the initial second object set.

Introduction is made to the selection of the target object based on Table 1. For example, a second object number threshold corresponding to the level information of the target user is 20. That is, an upper limit of the number of second objects that the game interface of the target user is capable to display is 20. That is, the number of sub areas corresponding to the target user is 20.

The number of second objects in the first area is 18. At this time, it may be determined that the target number of second objects that can be placed is 20−18=2. For example, all the second objects are the three second objects F1, F2, F3 in Table 1.

For example, the current time is 15 o'clock, the placing times threshold of each second object in the target refresh period is: F1/target refresh period [14 o'clock, 16 o'clock)/ placing times threshold 50; F2/target refresh period [14 o'clock, 16 o'clock)/placing times threshold 100, F3/target refresh period [8 o'clock, 18 o'clock)/ placing times threshold 100.

The target placing times (placed times) of each second object in the target refresh period is: F1/target refresh period [14 o'clock, 16 o'clock)/target placing times 50, F2/target refresh period [14 o'clock, 16 o'clock)/target placing times 80, F3/target refresh period [8 o'clock, 18 o'clock)/target placing times 50.

The initial second object set selected from all the second objects are: F2 and F3, because the target placing times (50) of F1 is equal to the corresponding placing times threshold (50), and the target placing times of F2 and F3 are less than corresponding placing times thresholds respectively.

S1007 may include selecting target number of second objects with higher priorities as the target objects. The second objects may be the same. For example, F2 has a higher priority, and remaining placing times of F2=100−80=20. The 20 is greater than the target number 2, so both the two second objects may be selected as F2.

In some embodiments, the target number of second objects may be selected from the initial second object set as the target objects according to the placing weight. For example, random numbers may be generated based on the placing weights, so that the target objects may be selected based on the random numbers. For example, a random number is selected when the random number is within a preset range. If the random numbers of F2 and F3 are both within the preset range, the target objects may be determined to be F2 and F3.

In some embodiments, the initial target objects may be elected based on priority first. If the number of selected initial target objects is greater than the target number, it means that further selection is needed. Selection may be further performed based on the placing weight until the target number of target objects are selected.

By making the selection of the target objects not only related to object placing configuration information, but also related to the current number of second objects in the first area and dynamic level information of the user, the flexibility of selecting the target objects is improved. In addition, by the setting of the placing weight/priority and the detection of whether the placing times threshold is reached, each second object may be placed according to the priority order, and the balance of the placing of the second object may be achieved.

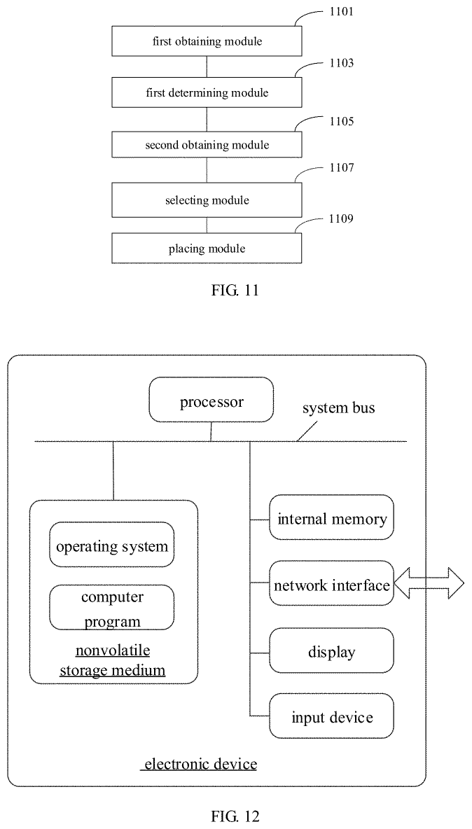

FIG. 11 is a block diagram illustrating an apparatus for placing a virtual object according to some embodiments of the disclosure. As illustrated in FIG. 11, the apparatus includes a first obtaining module 1101, a first determining module 1103, a second obtaining module 1105, a selecting module 1107, and a placing module 1109.

The first obtaining module 1101 is configured to obtain a position information and a first movement direction of a first object in a first area displaying a virtual space.

The first determining module 1103 is configured to determine a target area for placing a second object based on the position information and the first movement direction. The target area is outside the first area and is located by a side of the first area along the first movement direction.

The second obtaining module 1105 is configured to obtain object placing configuration information.

The selecting module 1107 is configured to select a target object from all second objects based on the object placing configuration information.

The placing module 1109 is configured to place the target object in the target area.

Based on the position information and the first movement direction of the first object in the first area displaying the virtual space, the target area for placing the second object is determined, so that the determination of the target area is related to the position in the virtual space in real time, and the target area can follow the real-time change of the position of the first object in the virtual space in real time, so as to ensure that the placing position of the second object can be changed in real time, improving the flexibility of placing an object. In addition, the target area is by the side of an edge of the first area that the first movement direction points to, so that the target area where the second object is placed is more in line with the real scene, which can ensure that the second object can naturally enter the first area in the subsequent time, making the simulation effect of the virtual space more realistic.

The apparatus further includes: a third obtaining module, configured to obtain a number of second objects in the first area periodically, and obtain level information of a target user corresponding to the virtual space; and a second determining module, configured to determine a second object number threshold corresponding to the level information.

The first obtaining module includes: a first obtaining unit, configured to obtain the position information and the first movement direction of the first object in the first area displaying the virtual space in response to the number of second objects in the first area less than the second object number threshold.

In some embodiments, first determining module includes: a first determining unit, configured to determine two straight lines at a preset distance from the position information, the two straight lines being respectively located at two sides of the first object, and being parallel to the first movement direction; a second obtaining unit, configured to intercept a target line segment on each of the two straight lines, the target line segment beings located by a side of the first area along the first movement direction; and a second determining unit, configured to connect end points of the target line segments sequentially to form the target area.

In some embodiments, the object placing configuration information includes a preset speed range corresponding to each second object. The placing module includes: a third obtaining unit, configured to obtain a first speed of the first object; a third determining unit, configured to determine a preset number of sub areas matching the level information, the preset number of sub areas being obtained by dividing a second area along the first movement direction, and the second area being obtained by splicing the first area and the target area; a selecting unit, configured to select a target sub area containing no second object from the preset number of sub areas; a fourth determining unit, configured to determine an initial position randomly in each target sub area, the initial position being located within the target area; a fifth determining unit, configured to determine a second speed and a second movement direction corresponding to the target object based on the preset speed range and the first movement direction; a sixth determining unit, configured to determine a target velocity in the target area of the target object based on the first speed, the second speed, and the second movement direction; and a placing unit, configured to place the target object at the initial position, and control the target object to move at the target velocity.

In some embodiments, the placing unit includes: a first obtaining sub unit, configured to obtain number information and a number weight corresponding to each target object; a first determining sub unit, configured to determine a target placing number corresponding to each target object based on the number information and the number weight; a second determining sub unit, configured to determine an initial position corresponding to each target object; and a placing sub unit, configured to place the target placing number of target objects at the initial position corresponding to each target object.

In some embodiments, the second movement direction is opposite to the first movement direction, and the first movement direction has a preset angle with a central axis of the first area. In some embodiments, the selecting module includes: a selecting unit, configured to select the target object from the all second objects based on the number of second objects in the first area, the second object number threshold and the object placing configuration information.

In some embodiments, the object placing configuration information includes a mapping relationship among each second object and at least one of a refresh time point, a placing times threshold in each refresh period, a placing weight, and a priority. The selecting unit includes: a third determining sub unit, configured to determine a difference between the number of second objects in the first area and the second object number threshold as a target number; a second obtaining sub unit, configured to obtain a placing times threshold of each second object in a target refresh period and a target placing times of each second object in the target refresh period, the target refresh period being a refresh period matching current time; a first selecting sub unit, configured to select an initial second object set from the all second objects, target placing times of each second object in the initial second object set being less than a corresponding placing times threshold; and a second selecting sub unit, configured to select a target number of second objects from the initial second object set as the target object according to at least one of a placing weight and a priority of each object in the initial second object set.

In some embodiments, the apparatus further includes: an interaction module, configured to perform a preset operation in response to detecting the second object in the first area is triggered; and an alarm module, configured to perform an alarm processing in response to the preset operation not satisfying an operation condition.

With respect to the apparatus in the above embodiments, the specific manners for the respective modules to perform operations have been described in detail in the embodiments regarding the methods, which will not be elaborated herein.

FIG. 12 is a schematic diagram illustrating an electronic device for placing a virtual object according to some embodiments of the disclosure. The electronic device may be a terminal. The internal structure diagram may be as illustrated in FIG. 12. The electronic device includes a processor, a memory, a network interface, a display screen and an input device connected through a system bus. The processor of the electronic device is configured to provide calculation and control capabilities. The memory of the electronic device includes a nonvolatile storage medium and an internal memory. The nonvolatile storage medium stores an operating system and a computer program. The internal memory provides an environment for operations of the operating system and computer program in the nonvolatile storage medium. The network interface of the electronic device is configured to communicate with an external terminal through a network connection. The computer program is executed by the processor to realize a method for placing a virtual object. The display screen of the electronic device may be a liquid crystal display screen or an electronic ink display screen. The input device of the electronic device may be a touch layer covered on the display screen, or a button, a trackball or a touch pad arranged on the housing of the electronic device, or an external keyboard, touchpad, or mouse, etc.

Those skilled in the art may understand that the structure in FIG. 12 is only a block diagram of a part of the structure related to the solutions of the disclosure and may not constitute a limitation on the electronic device to which the solutions of the disclosure is applied. The specific electronic device may include more or less parts than shown in the figure or combine some parts or has a different arrangement of parts.

In some embodiments, an electronic device is also provided, including: a processor; and a memory for storing instructions executable by the processor. The processor is configured to execute the instructions to perform the method for placing a virtual object in the embodiments of the disclosure.

In some embodiments, a computer-readable storage medium is also provided. When instructions in the storage medium are executed by the processor of the electronic device, the electronic device may be caused to perform the method for placing a virtual object in the embodiments of the disclosure. The computer-readable storage medium may be a read only memory (ROM), a random access memory (RAM), a compact disc read only memory (CD-ROM), a floppy disk and an optical data storage device.

In some embodiments, a computer program product containing instructions is also provided. When the computer program product runs on a computer, the computer may be caused to perform the method for placing a virtual object in the embodiments of the disclosure.

Those skilled in the art may understand that all or part of processes in the above-mentioned embodiment methods may be implemented by instructing relevant hardware through a computer program. The computer program may be stored in a nonvolatile computer-readable storage medium. When the computer program is executed, it may include procedures of the above-mentioned method embodiments. Any reference to the memory, storage, database or other media used in the embodiments provided in the disclosure may include a nonvolatile and/or volatile memory. The nonvolatile memory may include a read only memory (ROM), a programmable ROM (PROM), an electrically programmable ROM (EPROM), an electrically erasable programmable ROM (EEPROM) or a flash memory. The volatile memory may include a random access memory (RAM) or an external cache memory. As an illustration and not a limitation, RAM is available in many forms, such as static RAM (SRAM), dynamic RAM (DRAM), synchronous DRAM (SDRAM), double data rate SDRAM (DDRSDRAM), enhanced SDRAM (ESDRAM), synchlink DRAM (SLDRAM), memory bus (Rambus) direct RAM (RDRAM), direct memory bus dynamic RAM (DRDRAM), memory bus dynamic RAM (RDRAM), etc.

Those skilled in the art will easily think of other embodiments of the disclosure after considering the specification and practicing the disclosure disclosed herein. The disclosure is intended to cover any variations, uses or adaptive changes of the disclosure. These variations, uses or adaptive changes follow the general principles of the disclosure and include common knowledge or conventional technical means in the technical field that are not disclosed in the disclosure. The description and the embodiments are to be regarded as exemplary only and the true scope and spirit of the disclosure are pointed out by the following claims.

It will be appreciated that the disclosure is not limited to the exact construction that has been described above and illustrated in the accompanying drawings, and that various modifications and changes may be made without departing from the scope thereof. It is intended that the scope of the disclosure only be limited by the appended claims.

What is claimed is:

1. A method for placing a virtual object, comprising:
obtaining a position information and a first movement direction of a first object in a first area displaying a virtual space;
determining a target area based on the position information and the first movement direction, wherein the target area is outside the first area and is located by a side of the first area along the first movement direction;
obtaining object placing configuration information;
selecting a target object from all second objects based on the object placing configuration information; and
placing the target object in the target area.

2. The method according to claim 1, further comprising:
obtaining a number of second objects in the first area periodically, and obtaining level information of a target user corresponding to the virtual space; and
determining a first threshold corresponding to the level information;
wherein said obtaining a position information and a first movement direction of a first object in a first area displaying a virtual space comprises:
obtaining the position information and the first movement direction of the first object in the first area displaying the virtual space in response to the number of second objects in the first area less than the first threshold.

3. The method according to claim 1, wherein said determining a target area based on the position information and the first movement direction comprises:
determining two straight lines at a preset distance from position information, wherein the two straight lines are respectively located at two sides of the first object, and are parallel to the first movement direction;
intercepting a target line segment on each of the two straight lines, wherein the target line segment is located by a side of the first area along the first movement direction; and
connecting end points of the target line segments sequentially to form the target area.

4. The method according to claim 2, wherein the object placing configuration information comprises a preset speed range corresponding to each second object, said placing the target object in the target area comprises:
obtaining a first speed of the first object;
determining a preset number of sub areas matching the level information, wherein the preset number of sub areas are obtained by dividing a second area along the first movement direction, and the second area is obtained by splicing the first area and the target area;
selecting a target sub area containing no second object from the preset number of sub areas;
determining an initial position randomly in each target sub area, wherein the initial position is located within the target area;
determining a second speed and a second movement direction corresponding to the target object based on the preset speed range and the first movement direction;
determining a target velocity in the target area of the target object based on the first speed, the second speed, and the second movement direction; and
placing the target object at the initial position, and controlling the target object to move at the target velocity.

5. The method according to claim 4, wherein said placing the target object at the initial position comprises:
obtaining number information and a number weight corresponding to each target object;
determining a target placing number corresponding to each target object based on the number information and the number weight;
determining an initial position corresponding to each target object; and
delivering the target placing number of target objects at the initial position corresponding to each target object.

6. The method according to claim 4, wherein the second movement direction is opposite to the first movement direction, and the first movement direction has a preset angle with a central axis of the first area.

7. The method according to claim 2, wherein said selecting a target object from all second objects based on the object placing configuration information comprises:
selecting the target object from the all second objects based on the number of second objects in the first area, the first threshold and the object placing configuration information.

8. The method according to claim 7, wherein the object placing configuration information comprises a mapping relationship among each second object and at least one of a refresh time point, a placing times threshold in each refresh period, a placing weight, and a priority, said selecting the target object from all second objects based on the number of second objects in the first area, the first threshold and the object placing configuration information comprises:
determining a difference between the number of second objects in the first area and the first threshold as a target number;
obtaining a placing times threshold of each second object in a target refresh period and a target placing times of each second object in the target refresh period, wherein the target refresh period is a refresh period matching current time;
selecting an initial second object set from the all second objects, wherein target placing times of each second object in the initial second object set is less than a corresponding placing times threshold; and
selecting a target number of second objects from the initial second object set as the target object according to at least one of a placing weight and a priority of each object in the initial second object set.

9. The method according to claim 1, further comprising:
performing a preset operation in response to detecting the second object in the first area is triggered; and
performing an alarm processing in response to the preset operation not satisfying an operation condition.

10. An electronic device, comprising:
a processor; and
a memory for storing instructions executable by the processor;
wherein the processor is configured to execute the instructions to perform a method for placing a virtual object, the method comprising:
obtaining a position information and a first movement direction of a first object in a first area displaying a virtual space;
determining a target area based on the position information and the first movement direction, wherein the target area is outside the first area and is located by a side of the first area along the first movement direction;
obtaining object placing configuration information;
selecting a target object from all second objects based on the object placing configuration information; and
placing the target object in the target area.

11. The electronic device according to claim 10, wherein, the method further comprises:
obtaining a number of second objects in the first area periodically, and obtaining level information of a target user corresponding to the virtual space; and
determining a first threshold corresponding to the level information;
wherein said obtaining a position information and a first movement direction of a first object in a first area displaying a virtual space comprises:
obtaining the position information and the first movement direction of the first object in the first area displaying the virtual space in response to the number of second objects in the first area less than the first threshold.

12. The electronic device according to claim 10, wherein said determining a target area based on the position information and the first movement direction comprises:
determining two straight lines at a preset distance from the position information, wherein the two straight lines are respectively located at two sides of the first object, and are parallel to the first movement direction;
intercepting a target line segment on each of the two straight lines, wherein the target line segment is located by a side of the first area along the first movement direction; and
connecting end points of the target line segments sequentially to form the target area.

13. The electronic device according to claim 11, wherein the object placing configuration information comprises a preset speed range corresponding to each second object, and said placing the target object in the target area comprises:
obtaining a first speed of the first object;
determining a preset number of sub areas matching the level information, wherein the preset number of sub areas are obtained by dividing a second area along the first movement direction, and the second area is obtained by splicing the first area and the target area;
selecting a target sub area containing no second object from the preset number of sub areas;
determining an initial position randomly in each target sub area, wherein the initial position is located within the target area;
determining a second speed and a second movement direction corresponding to the target object based on the preset speed range and the first movement direction;
determining a target velocity in the target area of the target object based on the first speed, the second speed, and the second movement direction; and
placing the target object at the initial position, and controlling the target object to move at the target velocity.

14. The electronic device according to claim 13, wherein said placing the target object at the initial position comprises:
obtaining number information and a number weight corresponding to each target object;
determining a target placing number corresponding to each target object based on the number information and the number weight;
determining an initial position corresponding to each target object; and
placing the target placing number of target objects at the initial position corresponding to each target object.

15. The electronic device according to claim 13, wherein the second movement direction is opposite to the first movement direction, and the first movement direction has a preset angle with a central axis of the first area.

16. The electronic device according to claims 11, wherein said selecting a target object from all second objects based on the object placing configuration information comprises:
selecting the target object from the all second objects based on the number of second objects in the first area, the first threshold and the object placing configuration information.

17. The electronic device according to claim 16, wherein the object placing configuration information comprises a mapping relationship among each second object and at least one of a refresh time point, a placing times threshold in each refresh period, a placing weight, and a priority, and said selecting the target object from all second objects based on the number of second objects in the first area, the first threshold and the object placing configuration information comprises:
determining a difference between the number of second objects in the first area and the first threshold as a target number;
obtaining a placing times threshold of each second object in a target refresh period and a target placing times of each second object in the target refresh period, wherein the target refresh period is a refresh period matching current time;
selecting an initial second object set from the all second objects, wherein target placing times of each second object in the initial second object set is less than a corresponding placing times threshold; and
selecting a target number of second objects from the initial second object set as the target object according to at least one of a placing weight and a priority of each object in the initial second object set.

18. The electronic device according to claim 10, wherein the method further comprises:
performing a preset operation in response to detecting the second object in the first area is triggered; and
performing an alarm processing in response to the preset operation not satisfying an operation condition.

19. A non-transitory computer-readable storage medium having stored therein instructions that, when executed by a processor of an electronic device, causes the electronic device to perform a method for placing a virtual object, the method comprising:
obtaining a position information and a first movement direction of a first object in a first area displaying a virtual space;
determining a target area based on the position information and the first movement direction, wherein the target area is outside the first area and is located by a side of the first area along the first movement direction;
obtaining object placing configuration information;
selecting a target object from all second objects based on the object placing configuration information; and
placing the target object in the target area.

20. The storage medium according to claim 19, wherein, the method further comprises:
obtaining a number of second objects in the first area periodically, and obtaining level information of a target user corresponding to the virtual space; and
determining a first threshold corresponding to the level information;
wherein said obtaining a position information and a first movement direction of a first object in a first area displaying a virtual space comprises:
obtaining the position information and the first movement direction of the first object in the first area displaying the virtual space in response to the number of second objects in the first area less than the first threshold.
